(19) United States
(12) Patent Application Publication
(10) Pub. No.: US 2025/0234192 A1
(43) Pub. Date: Jul. 17, 2025

(54) PREVENTION OF AUTHENTICATION ABUSE FOR WIRELESS CLIENTS

(71) Applicant: Cisco Technology, Inc., San Jose, CA (US)

(72) Inventors: Maithri BHAGAVAN, Bangalore (IN); Domenico FICARA, Essertines-Sur-Yverdon (CH); Raghu R. PAPPALA, Bangalore (IN); Geethanjali G. KALIBHAT, Bangalore (IN); Venkat Karthik MUKIDICHETTI, Bangalore (IN)

(21) Appl. No.: 18/412,087

(22) Filed: Jan. 12, 2024

(51) Int. Cl. H04W 12/06; H04L 9/08; H04L 9/32

(52) U.S. Cl. CPC H04W 12/06; H04L 9/0866; H04L 9/3213; H04L 9/3247

(57) ABSTRACT

Techniques for improved wireless network security are provided. A probe request is receiving at an AP and from a client device. A probe response comprising a time-lock puzzle is transmitted by the AP and to the client device. An authentication request comprising a solution for the time-lock puzzle is received at the AP and from the client device. In response to determining that the first solution is correct, authentication of the first client device is facilitated.

### TECHNICAL FIELD

Embodiments presented in this disclosure generally relate to wireless networking. More specifically, embodiments disclosed herein relate to prevention (or at least reduction) of authentication abuse in wireless networks.

### BACKGROUND

There are a variety of networking architectures available to provide wireless networking (e.g., in a wireless local area network (WLAN), such as a WiFi network). Generally, to connect to a wireless network, client devices go through an association process which includes authentication of the client. Wireless attacks have increased in frequency and sophistication in recent years, particularly with the recent increases in Internet of Things (IoT) devices. There are a variety of paths for an attacker to hack into or misuse the wireless services of a network. For example, many common attacks occur via Spoofing, denial of service (DoS) attacks, de-auth floods, and the like.

A variety of security enhancements have recently been introduced, such as via Beacon Protection (BIP) or Operating Channel Validation (OCV). However authentication floods are still possible in existing architectures (where a malicious client sends repeated authentication requests that consume the resources of the network and harm legitimate traffic and devices). With some recent security developments, such as WPA3, authentication operations have gotten more secure, but have also grown substantially heavier in terms of computational expense. This substantial expense (e.g., compute time, memory resource needs, and the like) makes malicious authentication floods a significant problem for access points (APs).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for improved authentication abuse prevention in wireless radio systems, according to some embodiments of the present disclosure.

FIGS. 2A, 2B, 2C, and 2D depict example workflows for improved authentication abuse prevention, according to some embodiments of the present disclosure.

FIG. 3 is a flow diagram depicting an example method for wireless authentication, according to some embodiments of the present disclosure.

FIG. 4 is a flow diagram depicting an example method for authentication abuse prevention, according to some embodiments of the present disclosure.

FIG. 5 is a flow diagram depicting an example method for performing authenticating a client device, according to some embodiments of the present disclosure.

FIG. 6 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, comprising: receiving, at an AP and from a first client device, a first probe request; transmitting, by the AP and to the first client device, a first probe response comprising a first time-lock puzzle; receiving, at the AP and from the first client device, a first authentication request comprising a first solution for the first time-lock puzzle; and in response to determining that the first solution is correct, facilitating authentication of the first client device.

One embodiment presented in this disclosure provides one or more non-transitory computer-readable media comprising computer-executable instructions that, when executed by one or more processors of a processing system, cause the processing system to perform an operation comprising: receiving, at an AP and from a first client device, a first probe request; transmitting, by the AP and to the first client device, a first probe response comprising a first time-lock puzzle; receiving, at the AP and from the first client device, a first authentication request comprising a first solution for the first time-lock puzzle; and in response to determining that the first solution is correct, facilitating authentication of the first client device.

One embodiment presented in this disclosure provides a system comprising: one or more computer processors; and logic encoded in one or more non-transitory media, the logic collectively executable by operation of the one or more computer processors to perform an operation comprising: receiving, at an AP and from a first client device, a first probe request; transmitting, by the AP and to the first client device, a first probe response comprising a first time-lock puzzle; receiving, at the AP and from the first client device, a first authentication request comprising a first solution for the first time-lock puzzle; and in response to determining that the first solution is correct, facilitating authentication of the first client device.

### Example Embodiments

Embodiments of the present disclosure provide techniques and operations for preventing (or at least reducing or discouraging) authentication abuse of wireless networks.

In many conventional systems, flooding and other DOS attacks that maliciously lead to resource exhaustion for the network rely on the assumption that some procedures are relatively cheap to perform (in terms of computational expense). For example, flooding an AP with authentication requests consumes computational resources of the AP (e.g., compute time, memory, and the like), which may prevent the AP from handling other workloads for legitimate clients. Further, such flooding may also consume substantial RF resources (e.g., spectrum availability), reducing the stability and capacity of the network for all devices.

In some systems, client devices (referred to in some aspects as stations or STAs) can use any media access control (MAC) address to identify themselves during authentication. In some standards, such as 802.11bh, there are a number of different proposals for client devices and APs to cooperate in order for the client devices to be identified as they join with a new MAC address. However, these proposals invariably rely on the client device choosing whether to cooperate. Therefore, an attacker may still transmit authentication requests from any number of random MAC addresses. In conventional systems, such an attack would be virtually indistinguishable from an equal number of legitimate client devices attempting to authenticate. That is, when N authentication requests are received from different MAC addresses, the network may be unable to determine whether the requests are from N legitimate clients, or are all from a single malicious actor.

In some embodiments, techniques are provided to prevent (or at least reduce or discourage) such flooding by making those procedures computationally expensive enough for legitimate clients to accept the cost, but too computationally heavy for a malicious attacker to exploit them. In some embodiments, the system can further provide a preferential lane to recurring and/or cooperating clients to facilitate easy and computationally inexpensive association to legitimate devices.

In some embodiments, an AP may generate a time-lock puzzle for each client that requests any resource (e.g., authentication, Clear to Send (CTS) and/or Request to Send (RTS) messages, and the like). In some embodiments, the time-lock puzzle takes a configurable (or variable) amount of CPU time to be solved. For example, the AP may configure the time-lock puzzle to control how much time and/or computing resources are needed to solve the puzzle. This time-lock puzzle may then be shared to the client device in response to the resource request, and the AP may refrain from accepting or responding to any following requests from the same client device until the time-lock has been solved by the client.

In some embodiments, the time-lock puzzle complexity may be adaptively controlled or modified (e.g., by the AP or another network device such as a controller) based on previous history of the client and/or changing circumstances (e.g., if new client devices are more powerful than those previously seen, the AP may increase the lock complexity accordingly).

In some embodiments, the AP may share a time-lock puzzle to cooperating client devices that are able to change their MAC address. For example, the time-lock may be used as a mechanism to allow such clients to re-authenticate and be identified properly (hence gaining access to their services), while preventing or discouraging the client from changing their MAC address too often (e.g., because changing the MAC address may cause the AP to send a new (potentially harder) time-lock puzzle).

In some embodiments, the system can ensure that recurrent clients are not required to solve a time-lock puzzle when they reconnect. For example, in some embodiments, the AP may provide, to authenticated clients, a free-pass token to bypass the puzzle. This token may be used at a future authentication to avoid going through the time-lock puzzle again. In some embodiments, this token can be used as part of other approaches (such as those that allow the client to change their MAC address) if the client device cooperates (e.g., the client may be able to bypass the time-lock even after changing their MAC address). In some embodiments, such a bypass token may be associated with an expiration (e.g., in terms of number of sessions or resources, time, and the like).

In some embodiments, when the AP sends a probe-response to a client, a time-lock challenge may be included as a part of this response. The client device then needs to decode or solve the puzzle before they are able to proceed to next stage of connection. In some such embodiments, when the client solves the time-lock puzzle and provides a response to the AP, the system moves to an authentication phase. Upon successful authentication, the AP may then generate a token key which the AP stores. The next time the same client device desires to connect to the network, the client may use the token to reconnect quickly. In some embodiments, an attacker or failed client will either fail the time-lock puzzle, or will fail the authentication phase, and therefore will not receive a token and will not be able to bypass future authentications.

In some embodiments, the additional overhead on the AP caused by using such time-lock puzzles and may be minimal. For example, the puzzles generally cause overhead for the client devices to resolve, but the AP may simply perform a computationally inexpensive memory access and/or string compare operation to verify the results. In some embodiments, the AP may only compare challenge responses with the stored challenge solutions (stored when the time-lock puzzle is created) so the additional overhead on the AP is minimal (even if a malicious client repeatedly sends false or invalid solutions).

In some embodiments, each client is presented with a different time-lock puzzle. Therefore, if an attacker spoofs the challenge response (e.g., attempting to provide a solution for a puzzle received by another client), the response will be deemed invalid for their connection. In some embodiments, the difficulty level of the time-lock puzzles may further be adjusted dynamically based on the client device. For example, the puzzle may be made more difficult for new clients and/or clients that frequently or have previously failed authentication. In contrast, existing or recurring clients may receive relatively easier puzzles. Depending on number and/or recency of failed attempts, the complexity of puzzle may be increased.

In these ways, wireless systems are able to prevent (or at least reduce) malicious attacks caused by flooding requests (e.g., authentication requests or requests for other services) from malicious actors, while maintaining efficient access for legitimate client devices.

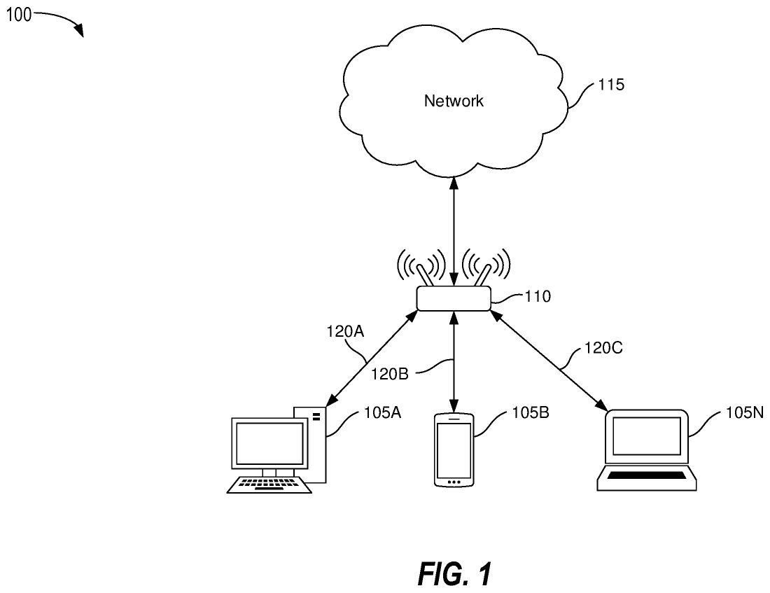

FIG. 1 depicts an example environment 100 for improved authentication abuse prevention in wireless radio systems, according to some embodiments of the present disclosure.

In the illustrated example, a set of client devices 105A-N are associated to a wireless AP 110 via links 120A-C. For example, the client devices 105A-N may have associated and been authenticated (e.g., by providing a username and password, and/or by providing a password for the network itself) by the AP 110. The AP 110 may generally facilitate or provide communication among connected devices (e.g., forwarding packets sent from one client device 105A to another client device 105B via the links 120A and 120B). In some embodiments, the AP 110 further provides or facilitates access to a broader network 115 (e.g., the Internet). For example, the AP 110 may transmit data from client devices 105 to other devices via the network 115, and/or transmit data received from the network 115 to the client devices 105.

Although three client devices 105 are depicted, there may be any number and variety of client devices 105 in the environment. The client devices 105 are generally representative of any STA device that may connect to and transmit data using a wireless network (e.g., a WiFi network or other WLAN) provided by the AP 110. For example, the client devices 105 may include laptops, desktops, tablets, smartphones, wearables, loT devices, and the like. Although a single AP 110 is depicted for conceptual clarity, in some embodiments, multiple APs 110 may be used to collectively provide the network (e.g., in a mesh architecture). Additionally, in some embodiments, other systems or components may be used. For example, in some embodiments, a wireless controller (e.g., a WLAN controller (WLC)) may be used to manage the AP(s) 110 and/or association or authentication process.

In the illustrated environment 100, when a client device 105 attempts to associate to the AP 110 (e.g., to establish a link 120), the AP 110 (or another component, such as a wireless controller) may generate a time-lock puzzle for the client device 105 to solve.

In some embodiments, the AP 110 uses an Extensible Authentication Protocol (EAP) approach to associate client devices 105. For example, the AP 110 may optionally transmit beacon(s) (e.g., in a broadcast fashion) including information about the network(s) the AP 110 provides, such as the capabilities of the AP 110 and/or network, supported data rates, Service Set Identifiers (SSIDs) the AP 110 hosts, and the like. In some embodiments, client devices 105 desiring to associate to the AP 110 (e.g., to an SSID the AP 110 provides) may transmit a probe request to the AP 110. The probe request generally identifies the client device 105 (e.g., using a MAC address) and requests information about networks of the AP 110 (e.g., requesting information for a specific SSID, or for any SSIDs the AP 110 provides). In some embodiments, in response to the probe request, the AP 110 may transmit a probe response to the requesting client device 105. The probe response may generally include similar information to the beacon frame(s), such as advertising the supported SSIDs, data rates, encryption types, and the like. In some embodiments, the AP 110 includes the time-lock puzzle in the probe response.

In some embodiments, based on the probe response, the client device 105 may then transmit an authentication request (e.g., based on determining, from the probe response, to connect to one of the SSIDs the AP 110 provides). In some embodiments, this authentication request includes the solution to the time-lock puzzle, as well as any relevant credentials that can be used to authenticate the client device 105 (e.g., a username and/or password). In response, the AP 110 may validate the puzzle solution. If validated, the AP 110 may then authenticate (or attempt to authenticate) the client device 105 (e.g., based on the provided credentials). The AP 110 may then transmit an authentication response to the client device 105. In some embodiments, if the client device 105 is successfully authenticated, the response may indicate this success. The client device 105 may then transmit an association request to actually establish the link 120. In response, the AP 110 may establish the associated link 120 and return an association response.

Generally, generating the time-lock puzzle is a computationally inexpensive process. For example, the AP 110 may use a cryptographic challenge similar to the LCS35 challenge (but with configurable difficulty, such as via different digit lengths) by computing a product of two (secret) prime numbers, which may be randomly-selected or may be chosen to configure the solution difficulty (e.g., where lower prime numbers may be relatively easier to solve). The client is then tasked with finding the factorization of the product (e.g., finding the two prime numbers that were multiplied), which generally requires successive squarings. By storing the challenge solution (along with an identifier of the client device 105, such as a MAC address), the AP 110 can easily and efficiently compare client responses with the existing solutions.

The AP 110 can then ignore any further responses or requests from the client device 105 (e.g., requests specifying the same client MAC address) until the client device 105 either provides a solution to the time-lock puzzle, or the puzzle has expired (e.g., after a defined period of time has elapsed).

In some embodiments, as discussed above, if the client device 105 fails to successfully solve the challenge, the AP 110 may store an indication or identifier of the client device 105 (e.g., a MAC address) along with an indication that the client device 105 previously failed to solve a time-lock puzzle. For example, the AP 110 may track how many times the client device 105 has failed the puzzle, how much time has elapsed since the first time and/or the most recent time when the client failed, and the like. Such information may be used to help adapt challenge difficulty for future requests from the client device 105 (e.g., making the challenge difficulty directly proportional to the number of times that the client device 105 failed the challenge, and/or inversely proportional to how much time has elapsed since the client device 105 last failed the challenge).

In some embodiments, if the client device 105 successfully solves the challenge and provides a legitimate solution, the AP 110 may begin the next phase of association (e.g., client authentication). If the client device 105 fails this authentication, the process may terminate. In some embodiments, the AP 110 may store an indication or identifier of the client device 105 (e.g., a MAC address) along with an indication that the client device 105 previously failed authentication. For example, the AP 110 may track how many times the client device 105 has failed authentication, how much time has elapsed since the first time and/or the most recent time when the client failed authentication, and the like. Such information may be used to help adapt challenge difficulty for future requests from the client device 105 (e.g., making the challenge difficulty directly proportional to the number of times that the client device 105 failed authentication, and/or inversely proportional to how much time has elapsed since the client device 105 last failed authentication).

Generally, a wide variety of client characteristics (including information about previous connection attempts) may be used to adapt the puzzle difficulty (e.g., using more difficult puzzles for more computationally powerful devices, using more difficult puzzles for devices having known vulnerabilities or that may be compromised, using simpler puzzles for devices that have successfully authenticated in the past, and the like). In some embodiments, the AP 110 may use a configurable maximum difficulty (such as to ensure that the puzzle can be solved in less than ten seconds) regardless of the client characteristics.

In some embodiments, if the client device 105 passes authentication, the AP 110 may establish the link 120 to the client device 105. In some embodiments, the AP 110 may store an indication or identifier of the client device 105 (e.g., a MAC address) along with an indication that the client device 105 was successfully authenticated. For example, the AP 110 may track how many times the client device 105 has authenticated, how much time has elapsed since the first time and/or the most recent time when the client authenticated, and the like. Such information may be used to help adapt challenge difficulty for future requests from the client device 105 (e.g., making the challenge difficulty inversely proportional to the number of times that the client device 105 authenticated, and/or directly proportional to how much time has elapsed since the client device 105 last authenticated).

In some embodiments, once the client device 105 successfully authenticates, the AP 110 may generate a bypass token that allows the client device 105 to skip or bypass one or more future challenges. The AP 110 may store an indication of the token (e.g., indicating the client's MAC address, as well as any characteristics of the token, such as an expiry time, a maximum number of uses, and the like), and transmit the token to the client device 105. Subsequently, when the client device 105 desires to re-associate to the network, the client device 105 may provide the bypass token. In response, the AP 110 may validate the token (e.g., confirm that the token matches the client's MAC address, that the token has at least one use left and has not expired, and the like). Once the token is validated, the AP 110 may refrain from generating a time-lock puzzle for the client device 105, and may instead proceed directly to authentication.

In these ways, malicious clients have a substantial disincentive to flood the AP 110 with requests. For example, a malicious client device will have to solve a time-lock puzzle (consuming resources) for each malicious request, severely limiting the number and frequency that such attacks may be sent. Further, the difficulty of such puzzles may be rapidly increased for suspected malicious clients (e.g., due to frequent failure of previous authentications, and/or use of a random MAC that is not known by the AP 110), further disincentivizing malicious attacks by the client. In these ways, embodiments of the present disclosure can reduce or prevent network attacks, preserving the resources of the AP 110 (and the network as a whole) for legitimate users. This substantially improves the operations and functionality of the wireless system.

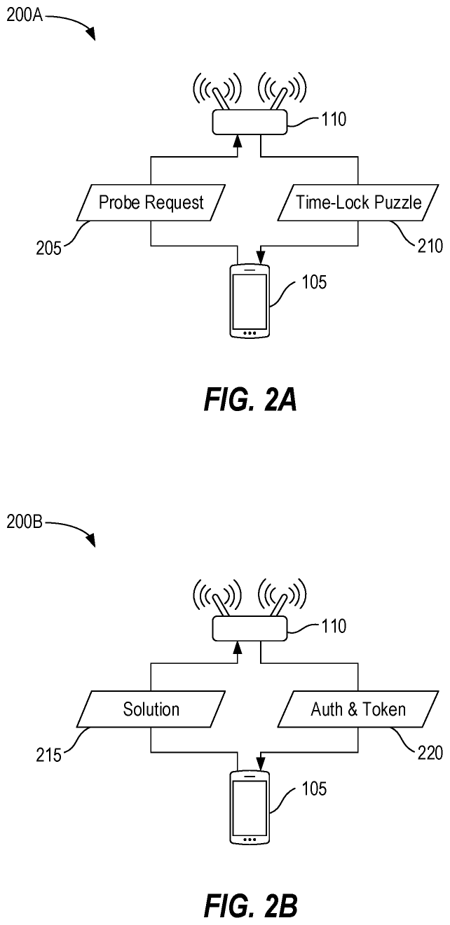

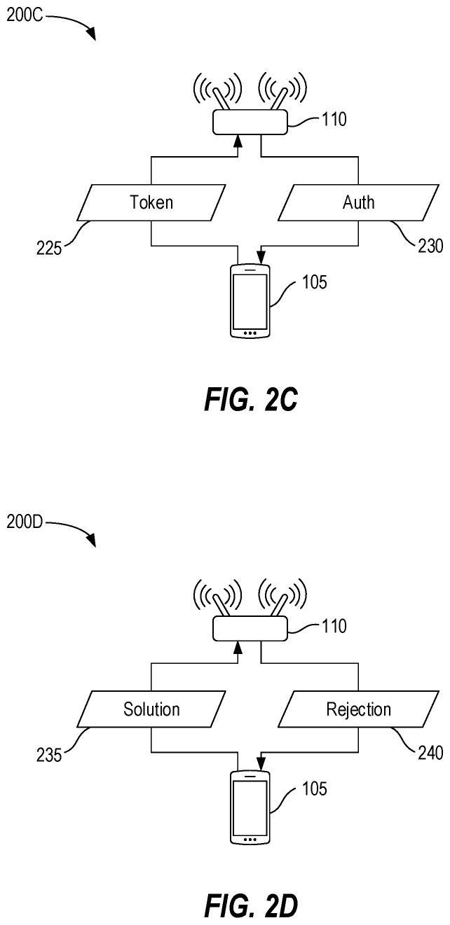

FIGS. 2A, 2B, 2C, and 2D depict example workflows 200 for improved authentication abuse prevention, according to some embodiments of the present disclosure.

In the illustrated workflow 200A, depicted in FIG. 2A, a client device 105 transmits a probe request 205 to an AP 110. As discussed above, the probe request 205 may generally include or correspond to a request for information about any network(s) the AP 110 supports or provides, such as the SSID(s), data rates, and the like. In response, as illustrated, the AP 110 transmits a time-lock puzzle 210 to the client device 105. In some embodiments, as discussed above, this time-lock puzzle 210 is included in a probe response frame. For example, the probe response may provide the relevant network information (e.g., data rates and SSIDs), along with a time-lock puzzle 210. If the client device 105 wishes to connect to an indicated SSID, the client device 105 must solve the time-lock puzzle.

In some embodiments, as discussed above, the AP 110 may dynamically adapt the difficulty of the time-lock puzzle 210 based on various characteristics of the client device 105. For example, the AP 110 may determine whether the client device 105 has previously failed and/or succeeded in solving a previous time-lock puzzle, whether the client device 105 has previously failed and/or succeeded authentication, how much time has passed since the client device 105 last attempted to connect, how frequently the client device 105 attempts to connect, and the like. This allows the AP 110 to scale the difficulty of the puzzle based on the likelihood that the client device 105 is acting maliciously.

As illustrated in the workflow 200B of FIG. 2B, the client device 105 then solves (or attempts to solve) the time-lock puzzle 210 (e.g., to find the pair of prime numbers that were multiplied together to create the time-lock puzzle 210). The client device 105 can then transmit a solution 215 to the AP 110 (e.g., indicating the prime numbers). In some embodiments, the solution 215 is included as part of an authentication request, as discussed above. For example, the client device 105 may indicate which SSID to connect to, and include various credentials (e.g., the solution 215 itself, as well as any other credentials such as an SSID password).

As illustrated, the AP 110 then authenticates (or attempts to authenticate) the client device 105. For example, the AP 110 may first validate the solution 215 to determine whether the client device 105 solved the time-lock puzzle 210. In some embodiments, as discussed above, the AP 110 may confirm that the solution 215 is correct for the specific puzzle that was transmitted to the specific client device 105, that a defined period of time has not elapsed, and the like. If the solution 215 is validated, the AP 110 may then facilitate or initiate authentication (e.g., using conventional approaches).

In the illustrated workflow 200B, if the authentication is successful, the AP 110 transmits an authentication and token 220 to the client device 105. For example, as discussed above, the AP 110 may transmit an authentication response and include the bypass token. In some embodiments, if the client device 105 fails authentication (e.g., if the solution 215 is invalid and authentication is not attempted, or if the solution 215 is valid but the authentication still fails), the AP 110 may transmit an authentication response indicating the failure. In some embodiments, as discussed above, the bypass token can be used to avoid future time-lock puzzles for one or more future association attempts. As discussed above, once the authentication response is received, the client device 105 may transmit an association response to establish a link with the AP 110.

In some embodiments, after authenticating the client device 105, the AP 110 may delete or remove the time-lock puzzle 210 from its memory or data store (e.g., removing the stored solution to free up space for other puzzles). In some embodiments, after authenticating the client device 105, the AP 110 may store an indication of the success. As discussed above, this success may affect the difficulty of a future time-lock puzzle for the client device 105.

As illustrated in the workflow 200C of FIG. 20, the client device 105 may subsequently determine to re-connect to the network. For example, the client device 105 may have temporarily switched to a different network, turned off networking radio(s), left the physical vicinity of the deployment, and the like. In some embodiments, to re-associate, the client device 105 transmits the previously provided token 225. For example, the client device 105 may transmit the token 225 in an authentication request to the AP 110 (rather than providing a solution to a newly provided puzzle), or in a probe request (to prevent the AP 110 from needing to generate a new time-lock puzzle).

In the illustrated example, the AP 110 validates the token 225 and returns authentication 230 (e.g., an authentication response). For example, the AP 110 may verify that the token 225 is associated with or belongs to the client device 105 (e.g., based on MAC address), that the token 225 has at least one additional authentication or use remaining (e.g., where the AP 110 decrements the number of allowable uses with each authentication), that the token 225 is not expired (e.g., a defined period of time has not elapsed since the token 225 was provided), and the like. As discussed above, once the authentication 230 is received, the client device 105 may transmit an association response to establish a link with the AP 110.

In some embodiments, if the token cannot be validated, the AP 110 may instead respond with a rejection and/or with a new time-lock puzzle for the client device 105. In some embodiments, as discussed above, the AP 110 may alter or adapt the difficulty of the time-lock puzzle based on client characteristics. For example, based on determining that the client device 105 had a previously valid token (e.g., the token was legitimate, but has expired), the AP 110 may determine to reduce the difficulty of the new puzzle below some default level. As another example, in response to determining that the token was invalid (e.g., the token was generated for a different client device, or was never valid), the AP 110 may determine to increase the difficulty of the puzzle above the default level.

In the workflow 200D of FIG. 2D, the client device 105 transmits a solution 235 to (attempt to) solve a time-lock puzzle provided by the AP 110 (e.g., in a previous probe response). In the illustrated example, however the AP 110 returns a rejection 240. For example, the AP 110 may determine that the solution 235 is incorrect for the puzzle that was provided to the client device 105 (e.g., it does not match any solution in the AP's memory, or it is correct for a different puzzle that was provided to a different client device). In some embodiments, the AP 110 may reject the solution 235 because the corresponding time-lock puzzle (that was provided to the client device 105) has expired (e.g., a defined duration of time has lapsed). In some embodiments, the AP 110 transmits the rejection 240 because the client device 105 failed authentication (even if the solution 235 was accurate).

In some embodiments, after failing to authenticate the client device 105 (e.g., determining that the solution 235 is incorrect, and/or that conventional authentication has failed), the AP 110 may delete or remove the time-lock puzzle 210 from its memory or data store (e.g., removing the stored solution to free up space for other puzzles). In some embodiments, as discussed above, the AP 110 may store an indication of the failure. As discussed above, this failure may affect the difficulty of a future time-lock puzzle for the client device 105.

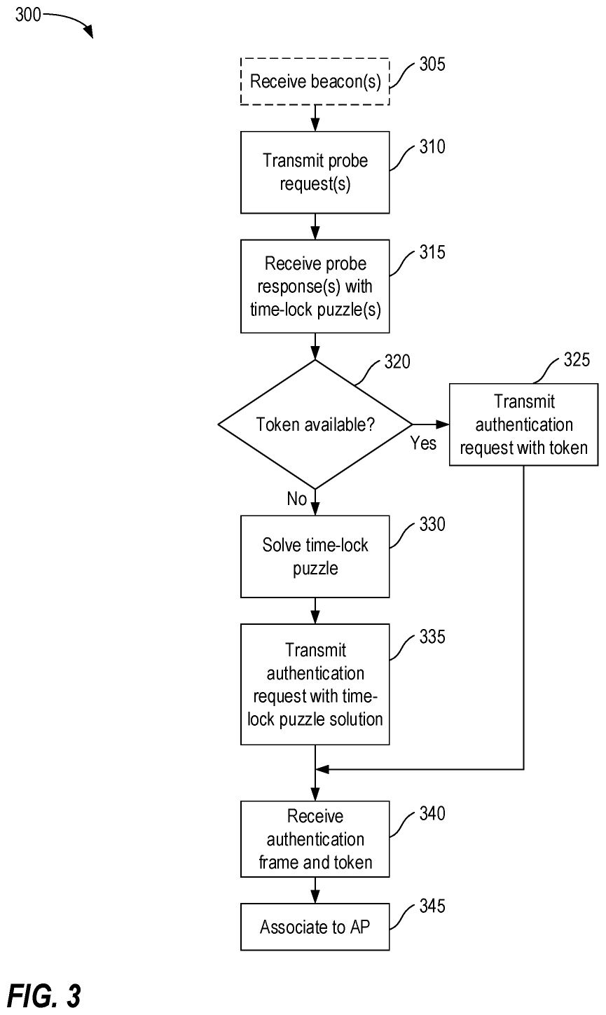

FIG. 3 is a flow diagram depicting an example method 300 for wireless authentication, according to some embodiments of the present disclosure. In some embodiments, the method 300 is performed by a client device, such as the client device 105 of FIGS. 1, 2A, 2B, 2C, and/or 2D.

At block 305, the client device optionally receives one or more beacon frames from one or more APs (e.g., the AP 110 of FIGS. 1, 2A, 2B, 2C, and/or 2D). As discussed above, such beacon frame(s) generally include information about the network(s) each AP supports, such as the SSIDs, supported data rates, available encryption types, and the like. In some embodiments, the client device may determine which AP(s) to connect to, which SSID(s) to connect to, what credentials are needed, and the like based at least in part on the beacons.

At block 310, the client device transmits one or more probe requests to one or more APs. For example, as discussed above, the probe request may identify the client device (e.g., using its MAC address) and request information for one or more networks provided the AP. For example, the client device may specify a specific SSID, or may request information on any SSIDs the AP hosts.

At block 315, the client device receives a probe response including a time-lock puzzle. As discussed above, the AP may generate the time-lock puzzle with a dynamic difficulty based on one or more characteristics of the client device (e.g., by looking up previous connection statistics for the client device).

At block 320, the client device determines whether a bypass token is available. That is, the client device may determine whether it has a previously received token that can be used to bypass the puzzle. For example, if the client device previously connected to the same AP and/or the same network, the AP may have previously provided a token to skip a subsequent puzzle.

If, at block 320, the client device determines that a token is available, the method 300 continues to block 325, where the client device transmits an authentication request and includes the token (rather than a solution to the puzzle). The method 300 then proceeds to block 340.

Returning to block 320, if the client device determines that a token is not available (e.g., because the client device has not previously connected to the network and/or AP, or because the token has expired), the method 300 continues to block 330. At block 330, the client device solves the received time-lock puzzle.

At block 335, the client device then transmits an authentication request and includes the solution (rather than a token). The method 300 then continues to block 340.

At block 340, the client device receives authentication (e.g., an authentication response indicating successful validation), along with a new bypass token, from the AP. In some embodiments, as discussed above, the AP may verify the provided solution and/or the provided token. In response to validating the solution or token, the AP may then authenticate the client device using other methods. In some embodiments, the AP only provides a token if the client device solved the puzzle. That is, in some embodiments, the AP may refrain from providing another token if the client device completed the current authentication using a previous token (at block 325). In this way, the client device may use the token for one or more connections, but then may be forced to complete a new time-lock puzzle (which may be a relatively easy puzzle, given the history of the connections), rather than continuously receiving new tokens.

At block 345, the client device associates to the AP based on the authentication response. For example, as discussed above, the client device may transmit an association request to establish one or more links to the AP. As discussed above, the client device can then use the association to exchange data with one or more other devices and/or networks via the AP.

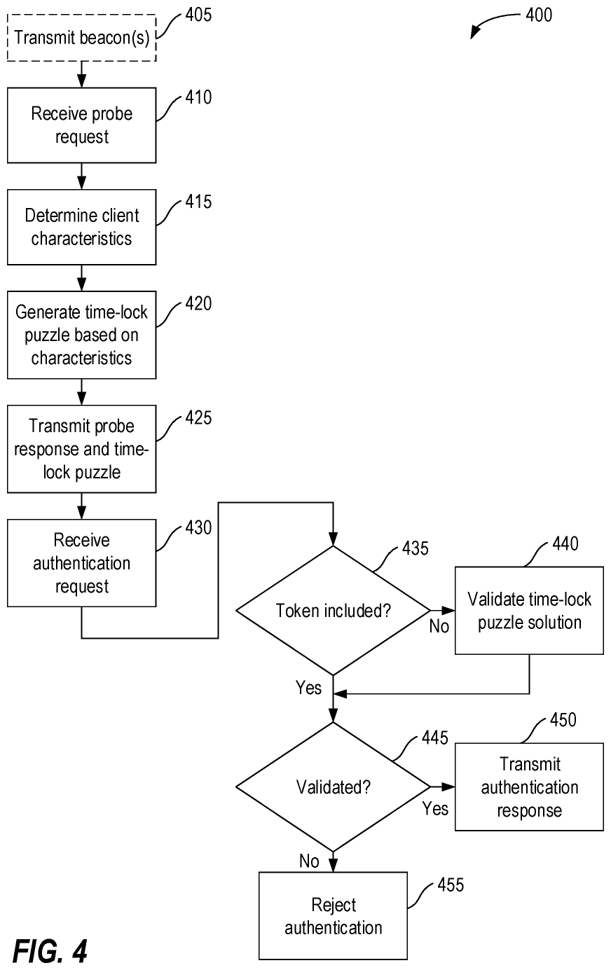

FIG. 4 is a flow diagram depicting an example method 400 for authentication abuse prevention, according to some embodiments of the present disclosure. In some embodiments, the method 400 is performed by an AP, such as the AP 110 of FIGS. 1, 2A, 2B, 2C, and/or 2D.

At block 405, the AP optionally transmits one or more beacon frames (e.g., in a broadcast manner). As discussed above, the beacons generally include information about the networks (e.g., SSIDs) supported by the AP. For example, the beacon may specify the SSID(s), supported data rates, and the like.

At block 410, the AP receives a probe request from a client device (e.g., the client device 105 of FIGS. 1, 2A, 2B, 2C, and/or 2D). As discussed above, the probe request may include a request for information for any networks (e.g., SSIDs) supported by the AP, and may specifically identify the SSID(s), indicate desired capabilities, and the like.

At block 415, the AP determines one or more client characteristics for the requesting client device. For example, based on the provided MAC address, the AP may determine whether the client device is a known device or an unknown device. In some embodiments, the AP may determine that the client device is “known” because the client previously transmitted a probe request to the AP (or to another AP associated with the AP performing the method 400), because the client previously passed a time-lock puzzle for the AP (or an associated AP), because the client was previously successfully authenticated by the AP (or an associated AP), and the like.

In some embodiments, the AP can determine further information such as whether the client device has ever successfully authenticated and/or failed to authenticate with the AP (or an associated AP), the number of times and/or frequency with which the client device previously attempted and/or succeeded in authentication with the AP (or an associated AP), how recently the client attempted and/or succeeded in authentication, and the like.

At block 420, the AP generates a time-lock puzzle for the client device based on the client characteristics. In some embodiments, as discussed above, the AP may increase or decrease the puzzle difficulty (e.g., increasing or decreasing the computational resources and/or time needed to solve the puzzle) above or below a default level. For example, the AP may decrease the difficulty in response to determining that the client device is a known device, in response to determining that the client device has previously succeeded in solving a previous puzzle and/or completing an authentication process, in response to determining that the client device has never failed a puzzle and/or authentication (or that a defined period of time has elapsed since such failure), and the like. As another example, the AP may increase the difficulty in response to determining that the client device is an unknown device, in response to determining that the client device has previously failed in solving a previous puzzle and/or completing an authentication process, in response to determining that the client device has never successfully completed a puzzle and/or authentication (or that a defined period of time has elapsed since such success), and the like.

In some embodiments, the puzzle difficulty may be directly proportional to the number of previous failures (e.g., inversely proportional to the number of successes), directly proportional to the time that has elapsed since the last success and/or inversely proportional to the time that has elapsed since the last failure, and the like.

In some embodiments, as discussed above, the AP may use a configurable maximum and/or minimum puzzle difficulty. For example, the AP may increase or decrease the difficulty for a given response, ensuring that the puzzle is not easier than the lowest permitted difficulty (e.g., requiring fewer resources and/or less time) nor harder than the highest permitted difficulty (e.g., requiring more resources and/or more time).

At block 425, the AP transmits, to the client device, a probe response including the generated time-lock puzzle. In this way, the AP indicates, to the client, that the client may attempt to authenticate after solving the provided puzzle.

At block 430, the AP receives an authentication request from the client device. As discussed above, this request may specify the SSID(s) to which the client device would like to establish a connection. In some aspects, the response may further include one or more credentials, such as a wireless network password, a solution to the time-lock puzzle, a bypass token for the puzzle, and the like.

At block 435, the AP determines whether the authentication request included a bypass token. If so, the method 400 continues to block 445. If the AP determines that the response did not include a token, the method 400 continues to block 440, where the AP validates the time-lock puzzle solution provided by the client device. For example, as discussed above, the AP may determine the correct solution (e.g., stored in association with the client's MAC address), and determine whether the provided solution matches the stored solution. The method 400 then continues to block 445.

At block 445, the AP determines whether the client device was successfully validated. For example, if a token was provided, the AP may determine whether the token is valid (e.g., not expired) and associated with the client device. If a solution was provided, the AP may determine whether the solution is correct. In some embodiments, if the token and/or solution is validated, the AP may then perform conventional authentication operations for the client device.

If, at block 445, the AP determines that the token and/or solution cannot be validated (or that the client device failed conventional authentication after successful validation), the method 400 continues to block 455. At block 455, the AP rejects authentication to the client device (e.g., transmits an authentication response declining to authenticate the client). In some embodiments, as discussed above, the AP may further update the client mappings to indicate that the client device failed to authenticate.

Returning to block 445, if the AP determines that the token and/or solution is valid (and that the client device passed conventional authentication after successful validation), the method 400 continues to block 450. At block 450, the AP grants authentication to the client device (e.g., transmits an authentication response accepting the client). In some embodiments, as discussed above, the AP may further update the client mappings to indicate that the client device successfully authenticated. In some embodiments, with the response, the AP may also generate and provide a bypass token for future use, as discussed above. The client device may then transmit an association request, and the AP may establish a link to the client.

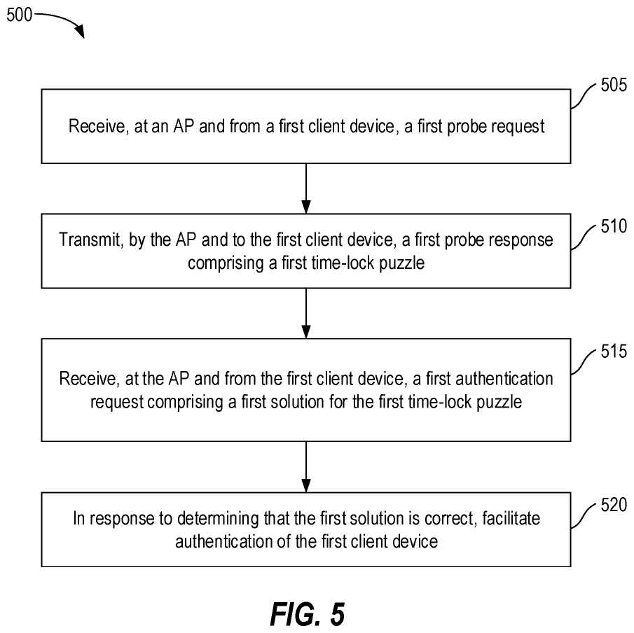

FIG. 5 is a flow diagram depicting an example method 500 for performing authenticating a client device, according to some embodiments of the present disclosure. In some embodiments, the method 500 is performed by an AP, such as the AP 110 of FIGS. 1, 2A, 2B, 2C, and/or 2D.

At block 505, a first probe request (e.g., the probe request 205 of FIG. 2A) is received at an AP (e.g., the AP 110 of FIGS. 1, 2A, 2B, 2C, and/or 2D) and from a first client device (e.g., the client device 105 of FIGS. 1, 2A, 2B, 2C, and/or 2D).

At block 510, a first probe response comprising a first time-lock puzzle (e.g., the time-lock puzzle 210 of FIG. 2A) is transmitted by the AP and to the first client device.

At block 515, a first authentication request comprising a first solution (e.g., the solution 215 of FIG. 2B) for the first time-lock puzzle is received at the AP and from the first client device.

At block 520, in response to determining that the first solution is correct, authentication of the first client device is facilitated.

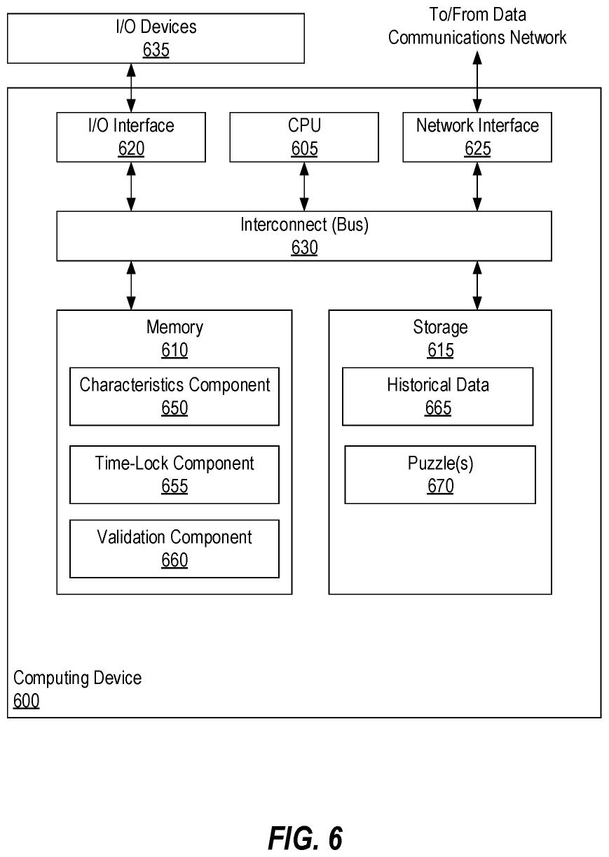

FIG. 6 depicts an example computing device configured to perform various aspects of the present disclosure, according to some embodiments of the present disclosure. Although depicted as a physical device, in embodiments, the computing device 600 may be implemented using virtual device(s), and/or across a number of devices (e.g., in a cloud environment). In one embodiment, the computing device 600 corresponds to an AP (e.g., the AP 110 of FIGS. 1, 2A, 2B, 2C, and/or 2D), and/or to a wireless controller that controls one or more APs.

As illustrated, the computing device 600 includes a CPU 605, memory 610, storage 615, a network interface 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated embodiment, the memory 610 includes a characteristics component 650, a time-lock component 655, and a validation component 660, which may perform one or more embodiments discussed above. Although depicted as discrete components for conceptual clarity, in embodiments, the operations of the depicted components (and others not illustrated) may be combined or distributed across any number of components. Further, although depicted as software residing in memory 610, in embodiments, the operations of the depicted components (and others not illustrated) may be implemented using hardware, software, or a combination of hardware and software.

The characteristics component 650 may generally be used to determine or infer characteristics of client devices that connect to (or request to connect to) the computing device 600. For example, the characteristics component 650 may evaluate historical data (such as the historical data 665) to determine whether a probe request was received from a known or unknown client, whether the client has previously succeeded or failed to authenticate, and the like. In some embodiments, the characteristics component 650 may further update the historical data 665 based on ongoing attempts (e.g., incrementing the count of the number of times a given client has attempted, failed, or succeeded in authentication).

The time-lock component 655 may generally be used to generate time-lock puzzles with dynamic or adaptive difficulty based at least in part on the historical data 665 or client characteristics. For example, as discussed above, the time-lock component 655 may use relatively more difficult puzzles (as compared to a default difficulty) for unknown clients and/or clients that recently failed authentication, and/or use relatively less difficult puzzles (as compared to a default difficulty) for known clients and/or clients that recently succeeded in authentication.

The validation component 660 may generally be used to validate provided time-lock puzzle solutions and/or tokens. For example, the validation component 660 may be used to compare returned solutions with puzzles 670 (e.g., solutions stored when the time-lock component 655 creates a time-lock puzzle), to determine whether a provided token is still valid, and the like.

In the illustrated example, the storage 615 includes historical data 665 and puzzles 670. The historical data 665 may generally include any information related to previous client connections, such as records of each successful and/or failed attempt to authenticate. In some embodiments, the puzzles 670 may include information about current puzzles (e.g., time-lock puzzles for which the validation component 660 is awaiting a response from a client), currently valid tokens (e.g., unexpired tokens which the validation component 660 has generated and provided to client devices), and the like.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, at an AP and from a first client device, a first probe request;
transmitting, by the AP and to the first client device, a first probe response comprising a first time-lock puzzle;
receiving, at the AP and from the first client device, a first authentication request comprising a first solution for the first time-lock puzzle; and
in response to determining that the first solution is correct, facilitating authentication of the first client device.

2. The method of claim 1, further comprising generating, by the AP, the first time-lock puzzle based on one or more characteristics of the first client device.

3. The method of claim 2, wherein:
the one or more characteristics of the first client device indicate that the first client device is an unknown device,
one or more characteristics of a second client device indicate that the second client device is a known device, and
generating the first time-lock puzzle comprises generating a problem that consumes additional resources to solve, as compared to a second time-lock puzzle generated for the second client device.

4. The method of claim 2, wherein
the one or more characteristics of the first client device indicate that the first client device is an known device,
one or more characteristics of a second client device indicate that the second client device is an unknown device, and
generating the first time-lock puzzle comprises generating a problem that consumes fewer resources to solve, as compared to a second time-lock puzzle generated for the second client device.

5. The method of claim 2, wherein
the one or more characteristics of the first client device indicate that the first client device has failed to solve at least one time-lock puzzle provided by the AP, and
generating the first time-lock puzzle comprises generating a problem that consumes additional resources to solve, as compared to a second time-lock puzzle generated for a second client device.

6. The method of claim 1, further comprising, in response to determining that the first client device has been authenticated, transmitting, from the AP and to the first client device, a token to bypass at least one time-lock puzzle for a future association.

7. The method of claim 6, further comprising:
receiving, at the AP and from the first client device, the token; and
authenticating, by the AP, the first client device based on the token.

8. The method of claim 6, further comprising:
receiving, at the AP and from the first client device, the token;
determining, by the AP, that the token has expired; and
transmitting, by the AP and to the first client device, a second probe response comprising a second time-lock puzzle.

9. The method of claim 1, further comprising:
receiving, at the AP and from a second client device, a second probe request;
transmitting, by the AP and to the second client device, a second probe response comprising a second time-lock puzzle;
receiving, at the AP and from the second client device, a second authentication request comprising a second solution for the second time-lock puzzle; and
in response to determining that the second solution was received after the second time-lock puzzle expired, declining authentication of the first client device.

10. One or more non-transitory computer-readable media comprising computer-executable instructions that, when executed by one or more processors of a processing system, cause the processing system to perform an operation comprising:
receiving, at an AP and from a first client device, a first probe request;
transmitting, by the AP and to the first client device, a first probe response comprising a first time-lock puzzle;
receiving, at the AP and from the first client device, a first authentication request comprising a first solution for the first time-lock puzzle; and
in response to determining that the first solution is correct, facilitating authentication of the first client device.

11. The one or more non-transitory computer-readable media of claim 10, the operation further comprising generating, by the AP, the first time-lock puzzle based on one or more characteristics of the first client device.

12. The one or more non-transitory computer-readable media of claim 11, wherein:
the one or more characteristics of the first client device indicate that the first client device is an unknown device,
one or more characteristics of a second client device indicate that the second client device is a known device, and
generating the first time-lock puzzle comprises generating a problem that consumes additional resources to solve, as compared to a second time-lock puzzle generated for the second client device.

13. The one or more non-transitory computer-readable media of claim 11, wherein
the one or more characteristics of the first client device indicate that the first client device has failed to solve at least one time-lock puzzle provided by the AP, and
generating the first time-lock puzzle comprises generating a problem that consumes additional resources to solve, as compared to a second time-lock puzzle generated for a second client device.

14. The one or more non-transitory computer-readable media of claim 10, the operation further comprising, in response to determining that the first client device has been authenticated, transmitting, from the AP and to the first client device, a token to bypass at least one time-lock puzzle for a future association.

15. The one or more non-transitory computer-readable media of claim 14, the operation further comprising:
receiving, at the AP and from the first client device, the token; and
authenticating, by the AP, the first client device based on the token.

16. A system comprising:
one or more computer processors; and
logic encoded in one or more non-transitory media, the logic collectively executable by operation of the one or more computer processors to perform an operation comprising:
receiving, at an AP and from a first client device, a first probe request;
transmitting, by the AP and to the first client device, a first probe response comprising a first time-lock puzzle;
receiving, at the AP and from the first client device, a first authentication request comprising a first solution for the first time-lock puzzle; and
in response to determining that the first solution is correct, facilitating authentication of the first client device.

17. The system of claim 16, the operation further comprising generating, by the AP, the first time-lock puzzle based on one or more characteristics of the first client device.

18. The system of claim 17, wherein:
the one or more characteristics of the first client device indicate that the first client device is an unknown device,
one or more characteristics of a second client device indicate that the second client device is a known device, and
generating the first time-lock puzzle comprises generating a problem that consumes additional resources to solve, as compared to a second time-lock puzzle generated for the second client device.

19. The system of claim 17, wherein
the one or more characteristics of the first client device indicate that the first client device has failed to solve at least one time-lock puzzle provided by the AP, and
generating the first time-lock puzzle comprises generating a problem that consumes additional resources to solve, as compared to a second time-lock puzzle generated for a second client device.

20. The system of claim 16, the operation further comprising, in response to determining that the first client device has been authenticated, transmitting, from the AP and to the first client device, a token to bypass at least one time-lock puzzle for a future association.
